(19) United States
(12) Patent Application Publication
(10) Pub. No.: US 2006/0150478 A1
(43) Pub. Date: Jul. 13, 2006

(54) Plant protection apparatus

(76) Inventor: Anton F. Gfesser, Schaumberg, IL (US)

Correspondence Address: GREER, BURNS & CRAIN, 300 S WACKER DR, 25TH FLOOR, CHICAGO, IL, 60606, US

(21) Appl. No.: 11/025,409

(22) Filed: Dec. 29, 2004

(51) Int. Cl. A01G 13/02

(52) U.S. Cl. 47/32.4

(57) ABSTRACT

Apparatus is disclosed for protecting young trees, saplings and other plants which comprises a frame structure having a plurality of spaced legs interconnected by at least one connecting ring, a plurality of upwardly and outwardly extending arms operatively connected to the legs, and barrier material attached to and extending at least between adjacent arms.

### BACKGROUND OF THE INVENTION

The present invention generally relates to plant protection apparatus.

Throughout much of the world, home and other property owners that have landscaped areas are at least occasionally confronted with the problem of protecting young trees that have been planted from damage that is inflicted by many kinds of relatively large animals, including deer, elk, mountain goats, antelope and other wild animals, depending upon the geographical area that the property is located.

In many rural as well as urban areas, deer are becoming ever more populated and tend to damage young trees in various ways. The bucks tend to sharpen their antlers on young trunks and most deer often browse off branches and tips of small trees, saplings and bushes. This problem is not new, and property owners have attempted to protect young trees for many decades if not longer. Often the tree may be surrounded by stakes driven into the ground around which a wire mesh, such as chicken wire is wrapped. Others use lengths of large diameter flexible drainage conduit that is cut along its length and fit around a tree. Even though the tree trunk can be protected by these and other similar materials and methods, the tree's canopy is still vulnerable to being eaten, particularly during winter when the ground may be covered by snow.

### SUMMARY OF THE INVENTION

Embodiments of the present invention for protecting young trees, saplings and other plants comprise a frame structure having a plurality of spaced legs interconnected by at least one connecting ring, a plurality of upwardly and outwardly extending arms operatively connected to the legs, and barrier material attached to and extending at least between adjacent arms.

### DETAILED DESCRIPTION OF THE DRAWINGS

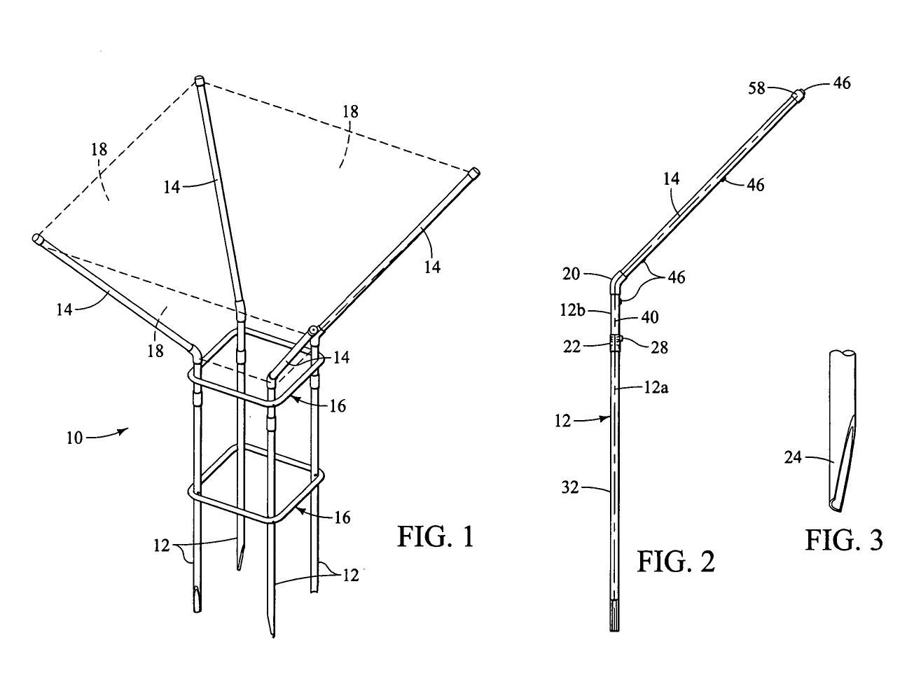

FIG. 1 is an elevated perspective view of the preferred embodiment of the present invention;

FIG. 2 is a side view of one of the assembled leg and arm portions of the apparatus shown in FIG. 1;

FIG. 3 is an enlarged side view of the lower end portion of the leg shown in FIG. 2;

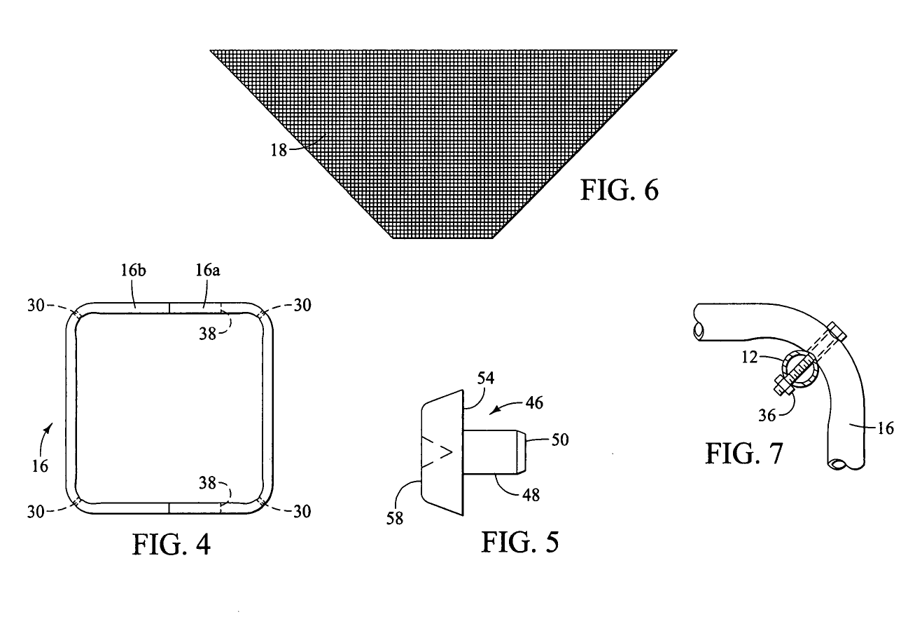

FIG. 4 is a top plan view of a connecting ring of the embodiment shown in FIG. 1;

FIG. 5 is an enlarged side view of a stem fitting of the embodiment shown in FIG. 1;

FIG. 6 is a plan view of a portion of the barrier material that is used with the preferred embodiment shown in FIG. 1; and

FIG. 7 is a plan view of a portion of the preferred embodiment illustrating the manner in which a connecting ring and leg portion.

### DETAILED DESCRIPTION

The preferred embodiment of the present invention is shown generally at 10 in the perspective view of FIG. 1 and is configured to be placed around the trunk of a tree or shrub for the purpose of protecting it from damage that may be caused by large animals such as deer, elk, moose, or other large animals. The plant protection apparatus is configured to not only protect the trunk of a relatively small tree or sapling, but also protect its canopy from being damaged or eaten by a deer or other large animal that may be foraging in the area.

The apparatus 10 is fabricated from generally commercially available components and is relatively easily assembled. Because of the materials that are used in its construction, it will have an extended useful life. Because of the simplicity of its design and installation, a young tree will be effectively protected while enabling a land owner to easily trim grass and weeds around the base of a tree or shrub in which it is installed. Also, watering and fertilizing of the plant can be easily performed without compromising the protection of the plant.

Because of its elegant design, it can be easily assembled by a person using only a screwdriver and the additional manual step of securing a plastic netting to the frame structure. The apparatus 10 generally comprises four legs 12, four arms 14 that are attached to the legs 12, a pair of connecting rings 16 that are connected to the legs 12 and a barrier material 18 that is connected to adjacent arms 14.

While the preferred embodiment that is shown in the drawings has four legs 12 that are arranged in a rectangle and particularly a square configuration, it should be understood that the apparatus can be fabricated using as few as three legs 12 or a larger number than the preferred four legs as shown. Similarly, the configuration of the connecting rings 16 can be circular rather than square, if desired, and while an arm 14 is shown to be operatively connected to each of the legs, an arrangement can be made whereby the arms 14 can be connected to the rings rather than the legs as shown. It should also be understood that the arms can be directly connected to the rings rather than the legs, although the preferred construction is shown in the drawings. The number of arms 14 can be greater or lesser than the number of legs 12. Additionally, while there are two connecting rings 16 shown in the preferred embodiment, it should also be understood that one connecting ring may be sufficient. Similarly, depending on the size of the apparatus 10, two, three or more connecting rings may be utilized to increase the structural integrity of the overall apparatus.

The legs 12 and arms 14 are shown in FIG. 2 as being connected to one another by a 45° angle fitting 20. The legs 12, arms 14 and fittings 20 are preferably fabricated from a plastic material, such as one inch diameter PVC tubing which is preferred because of its relatively light weight and high strength. While one inch diameter tubing is preferred, it should be understood that smaller or larger sized tubing can be utilized if desired.

The legs 12 have a lower section 12a that terminates in a straight fitting 22 in which a section 12b of the leg 12 fits into with the section 12b terminating in the angle fitting 20. While the arms 14, fittings 20, and sections 12a, 12b may be unassembled, it is preferred that some assembly be performed during the manufacturing process which will facilitate ease of assembly by the ultimate user even though the apparatus may be shipped in a relatively small carton. In this regard, the arm 14, fitting 20 and sections 12a, 12b may be polyvinyl chloride (PVC) components that are glued or fastened together. The straight fitting 22 is preferably glued to either the section 12a or section 12b. Regardless of which leg section the connector fitting 22 is glued to, a screw in the fitting 22 may engage the other section to hold it in place. It should also be understood that the angle fitting 20, while shown to be an approximately 45° angle relative to the leg 12, may be a different angle than shown, and can be within the range of approximately 30° to approximately 60°, depending upon the size and shape of the plant that is being protected.

As shown in the lower portion of FIG. 2 and in FIG. 3, bottom ends 24 of the legs 12 are preferably formed or cut so that the tips are pointed to facilitate driving the legs 12 into the ground during installation. In this regard, it is preferred that the legs 12 be driven into the ground approximately 6″ to assure that the apparatus will not be easily dislodged by wind or incidental contact by animals or others. It has been found that deer will not normally contact the apparatus, particularly if white PVC tubing and fittings are used, as it is their nature to avoid such structures that are present in their environment.

The angle of the fitting 20 as well as the length of the arms and legs can vary depending upon the animals that are believed to represent a danger to the plant being protected. The pointed lower end portions 24 are preferably configured by cutting the tubing from one side in a radial direction to approximately the center of the tubing and then cutting at an angle to a point from the radial cut to the end of the leg 12. While the length of the pointed portion may vary, it is preferred that it be approximately 4″ to 6″ which will facilitate its entry into the ground.

As previously stated, the fitting 22 is preferably glued to either the leg section 12a or 12b and a screw 28 may be placed through a hole in the fitting 12 and engage another hole in the unglued leg portion. It is preferred that the hole in the unglued portion be a smaller size than the diameter of the screw so that when the screw is installed, it will bind and hold the pieces together.

The connecting ring 16 is shown to have a square configuration with rounded corners and has holes at the corners oriented toward the center of the ring which are sized to receive a bolt 34 for bolting the ring 16 to the leg section 12a which also has a hole 32 for receiving the bolt 34. A nut 36 can then be tightened to hold each of the leg sections 12a to the connecting ring 16. It is also noted that the ring 16 is bifurcated in that it has a section 16a and a section 16b that can be slip fit together. While the slip fitting intersection is shown at 38 which is offset from center, it should be understood that the two sections 16a and 16b may be generally similar in size if the slip fit junction 38 is located at the center. A second ring is preferably provided and is also connected to sections 12b of the legs 12 through holes that are located at position 40.

It should be understood that a bifurcated connecting ring 16 is necessary so that the apparatus can be installed around a tree with this being done by generally connecting all of the arms and legs to the connecting rings 16 while they are separated and then installing them around a tree. It is possible to refrain from pre-drilling the holes and let the user do so, however, there are advantages in pre-drilling them. If they are pre-drilled, they can be at the correct angular position to orient the arms to extend outwardly from the center of the ring 16. Such alignment also has the benefit of a user only needing a screwdriver to assemble and install the apparatus 10.

To hold the barrier material 18 which is preferably a plastic netting, the leg sections 12b as well as the arms 14 have a number of holes located along their length in which a stem fitting, indicated generally at 46, shown in FIG. 5 as well as FIG. 2. Each stem fitting 46 has a generally cylindrical stem portion 48 with a beveled tip 50 and an enlarged head portion 52 that defined a retaining surface 54. The outside diameter of the stem portion 48 is preferably slightly smaller than the holes that are placed in the leg section 12b and the arms 14 so that they can be press fit into them as shown in FIG. 2. It is preferred that the stem fitting 46 be fabricated from plastic and preferably the same material that is used to make the legs 12 and arms 14 as well as the other fittings 20 and 22, but they can be made of a metal material that preferably does not rust. If they are fabricated of PVC material, the stem fittings 46 can be glued into the hole if desired. A cap 58 is preferably provided at the upper end of the arm 14, and it has a hole for receiving a stem fitting 46 at the end thereof.

While the barrier material 18 may be one continuous piece, it is preferred that it be made of sections having the shape as shown in FIG. 6, which conform to the area between adjacent arms. If the material 18 is an open plastic netting material, each of these sections can be installed by stretching them to overlie the stem fittings 46 so that they are retained by the bottom surface 54 of the fittings 46. While the stem fittings may reliably hold the material 18 to the arms 14 and the leg section 12b, it is desirable to use small cable ties, such as four inch Ty-Wraps®, for example, to fasten the material 18 to the arms 14 although other types of fasteners can be used.

The apparatus may be assembled and installed in various ways but a convenient order or procedure for assembling it is to start with separating one of the connecting rings into its two sections and connecting one of the sections to two of the leg sections 12a followed by connecting the portion 12b with two arms 16 to the same section of the second connecting ring 16. This then results in one-half of the total frame structure of the assembly being connected. The other half is then similarly assembled and at that point, the two halves of the frame structure can be taken to a tree for installation and this is done by placing the two halves on opposite sides and slip fitting the two connecting rings together. The legs can then be driven into the ground either by pushing them or by using a mallet or hammer using a 2×4 or other structural member that preferably spans opposite sides of a ring and the apparatus can be hammered into the ground. Once that has been completed, the netting can be installed between adjacent arms and Ty-Wraps® installed if desired and the assembly and installation is complete.

While various embodiments of the present invention have been shown and described, it should be understood that other modifications, substitutions and alternatives are apparent to one of ordinary skill in the art. Such modifications, substitutions and alternatives can be made without departing from the spirit and scope of the invention, which should be determined from the appended claims.

Various features of the invention are set forth in the following claims.

What is claimed is:

1. Apparatus for protecting a plant such as a young tree or sapling from damage caused by large animals, comprising:
a plurality of elongated legs spaced apart from one another and located around the plant;
at least a first connecting ring operatively connecting said legs to one another to provide structural rigidity to said legs;
a plurality of upwardly and outwardly extending arms operatively connected to the upper end of the legs, and
isolating material extending at least between substantially all adjacent arms.

2. Apparatus as defined in claim 1 wherein said apparatus has four legs surrounding said plant in a generally rectangular configuration.

3. Apparatus as defined in claim 2 wherein said rectangular configuration is generally square.

4. Apparatus as defined in claim 1 wherein said elongated legs have a tubular configuration.

5. Apparatus as defined in claim 1 wherein said elongated legs have a relatively pointed bottom end portion to facilitate being driven into the ground.

6. Apparatus as defined in claim 1 wherein said connecting ring is generally rectangularly shaped, and comprises two half sections that connect to one another.

7. Apparatus as defined in claim 1 wherein said connecting ring is comprised of metal and said arms and legs are made from plastic tubing and fittings.

8. Apparatus as defined in claim 1 wherein said arms are connected to said legs at a angle within the range of about 30 degrees to about 60 degrees.

9. Apparatus as defined in claim 1 further comprising a second connecting ring operatively connecting said legs to one another and spaced from said first connecting ring to provide additional structural rigidity to said legs.

10. Apparatus as defined in claim 1 wherein said isolating material comprising a plastic netting material having a plurality of openings of a predetermined size.

11. Apparatus as defined in claim 1 wherein said arms have openings located along the length thereof configured to receive a retaining member for attaching said isolating material to said arms.

12. Apparatus as defined in claim 8 further comprising an angled fitting interconnecting lower ends of said arms and upper ends of said legs.

13. Apparatus as defined in claim 1 wherein the installed height of the upper end of said arms is within the range of about 5 ft to about 8 feet from the ground.

14. Apparatus as defined in claim 10 wherein said netting has further comprising a plurality of stems are attached to said arms along their length, said stems having a top portion sized larger than the size of said openings in said netting, so that the netting can be stretched to fit over the top portion and hold said netting to said arms.

15. Apparatus as defined in claim 14 wherein said netting comprises a plurality of generally trapezoidal shaped pieces that are attached to said adjacent arms.

16. A method of assembling and installing a small plant protecting apparatus of the type which has a plurality of elongated legs, at least one bifurcated connecting ring that is larger than the bottom of the plant to be protected, an upwardly and outwardly extending arm for each leg and isolating material for attachment to the arms, said method comprising the steps of:
a) connecting each of a plurality of arms and legs together;
b) connecting approximately one half of said legs to each section of the at least one bifurcated connecting ring;
c) connecting the sections of the bifurcated connecting rings together around the bottom of the plant;
d) driving the legs into the ground a sufficient distance to hold the apparatus in place; and
e) attaching the isolating material between adjacent arms.

17. A method as defined in claim 16 comprising the further step of connecting approximately one half of the legs to each section of a second bifurcated connecting ring at a location along the legs that is spaced from the location of the one connecting ring.

18. A method as defined in claim 16 wherein steps a) and b) are reversed.
